(19) United States
(12) Patent Application Publication
(10) Pub. No.: US 2009/0225026 A1
(43) Pub. Date: Sep. 10, 2009

(54) Electronic device for selecting an application based on sensed orientation and methods for use therewith

(76) Inventor: Yaron Sheba, Mountain View, CA (US)

Correspondence Address: BRINKS HOFER GILSON & LIONE/SanDisk, P.O. BOX 10395, CHICAGO, IL, 60610, US

(21) Appl. No.: 12/074,934

(22) Filed: Mar. 6, 2008

(51) Int. Cl. G09G 5/00

(52) U.S. Cl. 345/156; 340/686.6

(57) ABSTRACT

An electronic device for selecting an application based on sensed orientation and methods for use therewith are provided. In one embodiment, an electronic device is provided comprising a display device, an orientation sensor, a memory storing a plurality of applications, and circuitry in communication with the display device, orientation sensor, and memory. The circuitry is operative to select one of the plurality of applications based on an orientation sensed by the orientation sensor. Other embodiments are disclosed, and each of the embodiments can be used alone or together in combination.

### BACKGROUND

Many electronic devices provide several different user-selectable applications. For example, an electronic device can contain a plurality of applications to allow the electronic device to function as a telephone, a digital audio and/or video player, and a web browser. Many such electronic devices use a graphical user interface to allow a user to select one such application. To facilitate selection, the graphical user interface can present a series of menus, and a user can use input elements to navigate the menus and make a selection. Some electronic devices have a touch screen, through which a user can make a selection, and such electronic devices can use a proximity detection system to detect when a finger is in close proximity of the touch screen and generate keys in the vicinity of an expected user touch.

Additionally, some electronic devices, such as the Apple iPhone, contain an orientation sensor for sensing the orientation of the device. Based on the sensed orientation, the iPhone can change the display of an application from a “portrait” view to a “landscape” view. For example, when the iPhone is running a web browser application, turning the device from a portrait orientation to a landscape orientation causes the iPhone to change the display of the web browser application from a portrait view to a landscape view to allow better viewing. A change in orientation can also change the type of graphical user interface of the running application. For example, when the iPhone is running a digital audio player application, turning the device from a portrait orientation to a landscape orientation causes the iPhone to provide a different graphical user interface for the digital audio player application. Specifically, in the landscape orientation, the digital audio player application provides a “Cover Flow” graphical user interface that allows a user to flip through album covers to select an album. In the portrait orientation, the digital audio player application displays an album cover but does not provide the “Cover Flow” graphical user interface.

### SUMMARY

The present invention is defined by the claims, and nothing in this section should be taken as a limitation on those claims.

By way of introduction, the embodiments described below provide an electronic device for selecting an application based on sensed orientation and methods for use therewith. In one embodiment, an electronic device is provided comprising a display device, an orientation sensor, a memory storing a plurality of applications, and circuitry in communication with the display device, orientation sensor, and memory. The circuitry is operative to select one of the plurality of applications based on an orientation sensed by the orientation sensor.

In another embodiment, the electronic device further comprises a user input element in communication with the circuitry. User manipulation of the user input element causes the circuitry to enter a mode of operation in which the circuitry is operative to select one of the plurality of applications based on the orientation sensed by the orientation sensor. The housing of the electronic device can be formed to indicate an orientation of the electronic device. In some embodiments, the plurality of applications are predetermined, while, in other embodiments, the plurality of applications are chosen by a user of the electronic device. The plurality of applications can take any suitable form, such as, a digital audio player application, a telephony application, a web browser application, and a digital video player application. In one presently preferred embodiment, the plurality of applications do not merely provide a different graphical user interface for a same application. In yet another embodiment, the electronic device comprises a proximity sensor operative to sense when a user's finger is in proximity to a location on the display device, and the circuitry is further operative to generate a graphical user interface near the location. Methods for use with such electronic devices are also provided. Other embodiments are disclosed, and each of the embodiments can be used alone or together in combination.

The embodiments will now be described with reference to the attached drawings.

### BRIEF DESCRIPTION OF THE DRAWINGS

FIG. 1 is a block diagram of an electronic device of an embodiment.

FIG. 2 is an illustration of an electronic device of an embodiment in a first orientation.

FIG. 3 is an illustration of an electronic device of an embodiment in a second orientation.

FIG. 4 is an illustration of an electronic device of an embodiment in a third orientation.

FIG. 5 is an illustration of an electronic device of an embodiment in a fourth orientation.

FIG. 6 is an illustration of a proximity-based graphical user interface displayed on an electronic device of an embodiment running a video player application.

FIG. 7 is an illustration of a proximity-based graphical user interface displayed on an electronic device of an embodiment running a web browser application.

### DETAILED DESCRIPTION OF THE PRESENTLY PREFERRED EMBODIMENTS

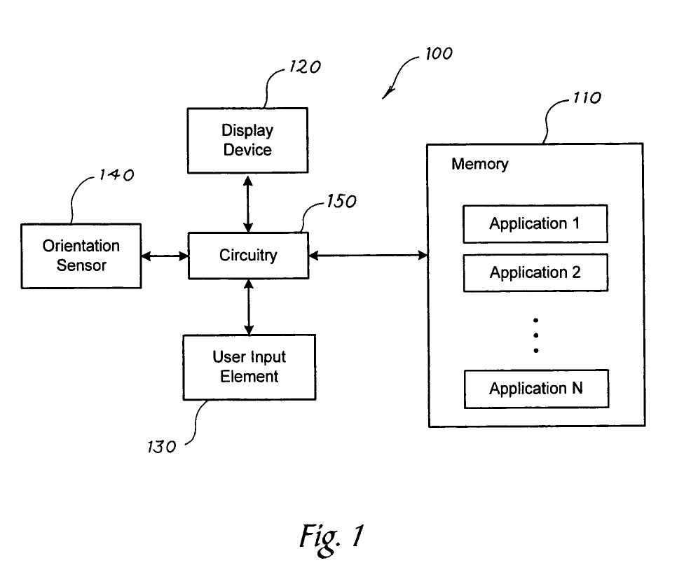

Turning now to the drawings, FIG. 1 is a block diagram of an electronic device 100 of an embodiment. As used herein, an “electronic device” refers to any device that uses electricity for some or all of its functionality. The electronic device 100 can be a wired or wireless device and, in some embodiments, takes the form of a portable handheld device. As shown in FIG. 1, the electronic device 100 of this embodiment comprises a memory 110 storing a plurality of applications (i.e., computer-executable program code) (Application 1, Application 2, . . . Application N) that, when executed, provide the electronic device 100 with certain functionality. The memory 110 can take any suitable form, such as, but not limited to, solid-state, magnetic, optical, or other types of memory. Examples of suitable applications include, but are not limited to, a digital audio player application, a telephony application, a web browser application, a digital video player application, a video game application, a digital camera application, an email application, a text messaging application, a calendar application, a notepad application, and a calculator application. Preferably, each application provides the electronic device 100 with different functionality (e.g., a music player versus telephony functionality) and not merely a different graphical user interface or a different mode of operation of the same application (e.g., as with the “Cover Flow” graphical user interface of the digital audio player on the Apple iphone).

The electronic device 100 also comprises a display device 120 (e.g., a liquid crystal display (LCD)) for providing a display (e.g., of the output of one of the applications) and a user input element 130 for accepting an input from a user. The electronic device 100 can have additional user input elements not shown in FIG. 1 (e.g., a keyboard, a keypad, one or more knobs, wheels, buttons, and/or switches, etc.). When in the form of a touch-screen, the display device 120 can also accept user input when a user touches a selection choice displayed on the display device 120. The electronic device 100 in this embodiment also comprises an orientation sensor 140 to sense the orientation of the electronic device 100. The orientation sensor 140 can comprise, for example (but without limitation) a gyro or a gravity-sensitive switch, such as a mercury switch or a ball switch.

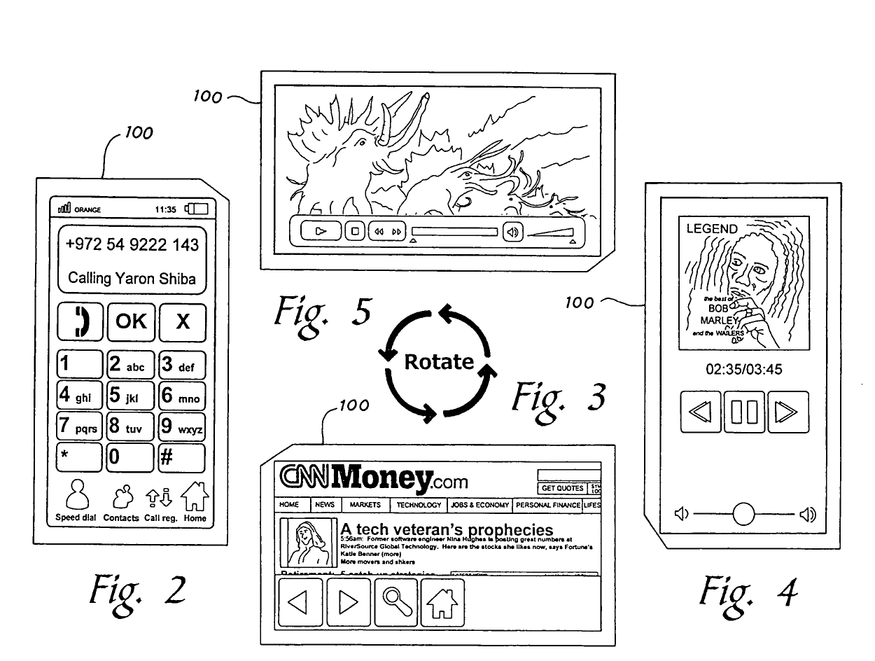

The electronic device 100 also comprises circuitry 150 in communication with the various components described above. As used herein, “in communication with” means in direct communication with or in indirect communication with through one or more components, which may be named or unnamed herein. “Circuitry” can include one or more components and can be a pure hardware implementation and/or a combined hardware/software (or firmware) implementation. Accordingly, “circuitry” can take the form of one or more of a microprocessor or processor that runs applications and other computer-readable program code stored in the memory 110 or in another storage location in the electronic device 100, as well as logic gates, switches, an application specific integrated circuit (ASIC), a programmable logic controller, and an embedded microcontroller, for example. In this embodiment, the circuitry 150 is operative to select one of the plurality of applications in the memory 110 based on an orientation sensed by the orientation sensor 140. (The circuitry 150 can also have other functions, such as running the general operation of the electronic device 100.) In a presently preferred embodiment, the user input element 130 is used to toggle between a first mode of operation in which the circuitry 150 is operative to select one of the plurality of applications based on an orientation sensed by the orientation sensor 140 and a second mode of operation in which the circuitry 150 does not perform this functionality. For example, in the second mode of operation, the circuitry 150 can select an application based on a user selection of a choice presented in a graphical user interface displayed on the display device 120 instead of based on an orientation sensed by the orientation sensor 140. The first mode of operation of the circuitry 150 will be illustrated below and in conjunction with FIGS. 2-4.

FIGS. 2-4 show the electronic device 100 in various orientations, and, in this embodiment, the various orientations are associated with various applications stored in the memory 110. When the orientation sensor 140 senses the orientation shown in FIG. 2, the circuitry 150 selects the application associated with this orientation. Here, that application is a telephony application. As shown in FIG. 2, the telephony application displays a telephone keypad and various related soft buttons (e.g., speed dial, contacts, call registry, dial, hang-up, etc.) as part of the graphical user interface displayed on the display device 120. With this application, the user can make or receive telephone calls and perform related tasks (e.g., retrieving/adding contact information, etc.).

If the user wants to switch applications, the user rotates the electronic device 100 to a different orientation. For example, FIG. 3 shows the electronic device being rotated 90 degrees counter-clockwise with respect to the orientation shown in FIG. 2. In this embodiment, when the orientation sensor 140 senses the orientation shown in FIG. 3, the circuitry 150 selects the web browser application. As shown in FIG. 3, the web browser application displays a web page and various navigation buttons (e.g., back, forward, magnify, home) as part of the graphical user interface displayed on the display device 120. Rotating the electronic device counter-clockwise by another 90 degrees causes the circuitry 150 to select the digital audio player application, and the associated graphical user interface is displayed on the display device 120, as shown in FIG. 4. This graphical user interface provides volume and playback controls and displays the album cover (if available) associated with a selected song. Rotating the electronic device counter-clockwise by another 90 degrees causes the circuitry 150 to select the digital video player application. FIG. 5 shows this application displaying a movie and volume and playback controls on the display device 120. Rotating the electronic device counter-clockwise by another 90 degrees causes the circuitry 150 to again select the telephone application (see FIG. 2).

It should be noted that, in some embodiments, the applications associated with the various orientations are predetermined and configured by an entity other than the end user. In this way, the manufacturer of the electronic device 100 can configure the electronic device 100 for optimal performance. For example, as shown in FIGS. 2-5, the video and web browser applications benefit more from a landscape view than a portrait view, and these applications are preset for the landscape orientations of the electronic device 100. However, in other embodiments, at least one of the applications is configured by the user of the electronic device 100. This provides flexibility in choosing both the applications associated with this “orientation selection” functionality and the type of view (landscape or portrait) used for each application.

There are many advantages associated with these embodiments. Because an application is selected based on the orientation of the electronic device 100, a user can select an application without having to look at the display device 120 to navigate menus or even find an icon on the touch screen that is associated with a desired application. This may be desirable in situations where viewing the display device and/or interacting with a touch screen is difficult. Consider, for example, a situation in which a person is jogging while listening to songs using the digital audio player of the electronic device 100. If the user needs to make or receive a telephone call while jogging, it is much easier for the user to simply change the orientation of the electronic device 100 (e.g., by rotating it 180 degrees, as in FIGS. 2 and 4) instead of, while still jogging, trying to view the display device 120 and press the appropriate key(s) to select the telephony application. Similarly, if the electronic device 100 is being used in a car to provide audio output to the car's speakers and the user needs to make a telephone call, it is much easier and safer for the user to change the orientation of the electronic device 100 than to take his eyes of the road to view the display device 120 to find the appropriate keys to change applications. In addition to providing simplicity, this “orientation selection” functionality provides the electronic device 100 with more character and with more entertainment value than a standard electronic device.

As noted above, in some embodiments, the user input element 130 is used to place the circuitry 150 in a mode of operation where changing orientation will result in changing applications. In this way, the user can selective enable/disable the “orientation selection” functionality. Disabling this functionality may be desired, for example, when the electronic device 100 is being used to play music but is placed in the user's bag or purse. In such a situation, the electronic device may be jostled around and change orientations without the user intending to change applications. To enable the functionality again, the user simply manipulates the user input element 130. In one presently preferred embodiment, the user input element 130 takes a form that is manipulatible by a user without requiring the user to actually view the display device 120. For example, the user input element 130 can take the form of a button or a wheel that has a distinct tactile feel, so the user can easily find and recognize the user input element 130. Thus, in those embodiments, even though changing an application would require both manipulation of the user input element 130 and a change in orientation of the electronic device 100, the manipulation of the user input element 130 would be relatively easy for the user to do (e.g., far less difficult than navigating through a series of displayed menus).

There are many alternatives that can be used with these embodiments. For example, the housing of the electronic device 100 can be formed in such a way as to provide a user with a visual or tactile indication of the device's orientation and, thus, a sense of which application is/will be provided. For example, in the illustrations shown in FIGS. 2-5, one of the edges of the electronic device 100 is cut or tapered, which provides a user with an indication of orientation. That is, when the cut is in the upper-right-hand corner (as in FIG. 2), the user would know that the electronic device 100 is in the “telephony orientation,” while when the cut is in the lower-left-hand corner (as in FIG. 4), the user would know the electronic device 100 is in the “audio player orientation.” Of course, the housing can be provided with any other suitable type of visual and/or tactile qualities. For example, different materials or shapes can be used on different parts of the device 100 (e.g., metal on the top and plastic on the bottom, wider on the top than the bottom, etc.).

Also, while the various applications described above were illustrated as being used independently from one another, some or all of these applications can be used together. For example, if a user would like to listen to music while using the web browser, the user can orient the electronic device 100 in the position shown in FIG. 4, select and start playback of a song, and then rotate the electronic device 100 in the position shown in FIG. 3. Once in that position, the circuitry 150 would select the web browser application and provide web output on the display device 120. However, the digital music application can still be running in the background and provide audio output. If the web browser application also needs to provide audio output, both audio outputs can be provided simultaneously, or rules can be used to select which of the two audio outputs to provide.

It should be noted that although the various orientations shown in FIGS. 2-5 are about 90 degrees apart, the circuitry 150 can select applications based on other orientations (e.g., some amount less or more than 90 degrees, rotation about a different axis, etc.). Further, while each orientation was associated with a specific application in the above illustrations, in another embodiment, rotating the electronic device to different orientations cycles through various applications either randomly or starting from whatever application was running as the starting orientation. Also, it should be noted that the electronic device 100 can comprise additional components that were not shown in FIG. 1 to simplify the drawing. These components can include, but are not limited to, a power input port, a power switch, an audio output port (e.g., a headphone jack), a video output port, a data port (e.g., a USB jack), a memory card slot, a wireless (e.g., RF or IR) transmitter and/or receiver, amplifiers, and digital-to-analog converters. Additionally, the electronic device 100 can contain applications that are not subject to the “orientation selection” functionally but are instead accessible only by other mechanisms (e.g., by navigating through menus, pressing an icon on a touch screen, etc.).

Different functionally can be used with these embodiments as well. For example, in some alternate embodiments, instead of a graphical user interface being displayed at a standard or predetermined location on the display device, a proximity sensor can be used to sense when a user's finger is in proximity to a location on the display device, and the circuitry can be further operative to generate a graphical user interface (e.g., with proximity touch keys) near the location. A proximity sensor can use any suitable technology, such as, but not limited to, electric field, capacitive, inductive, eddy current, hall effect, reed, magneto resistive, ultrasonic, acoustic, optical (e.g., optical visual light, optical shadow, optical color recognition, optical IR, etc.), heat, conductive, resistive, hear, sonar, and radar technologies.

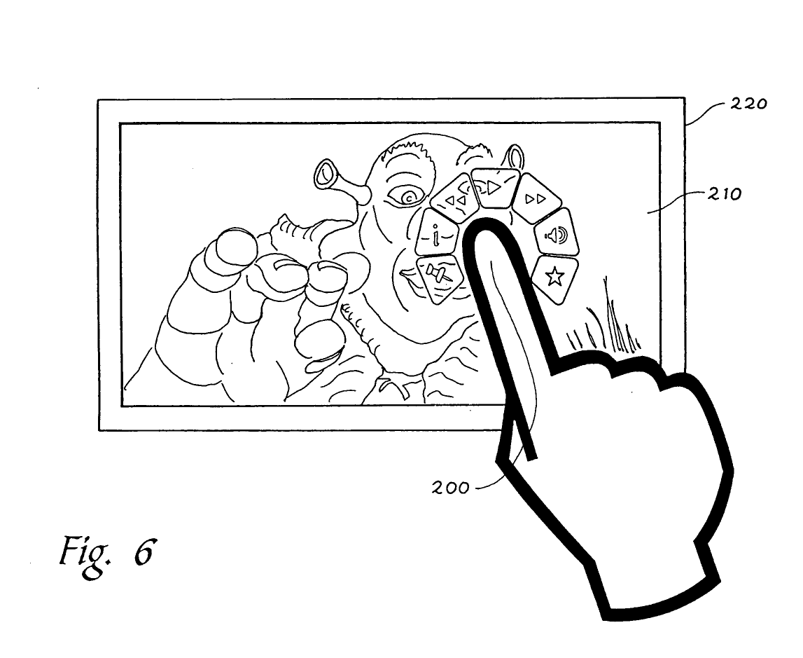

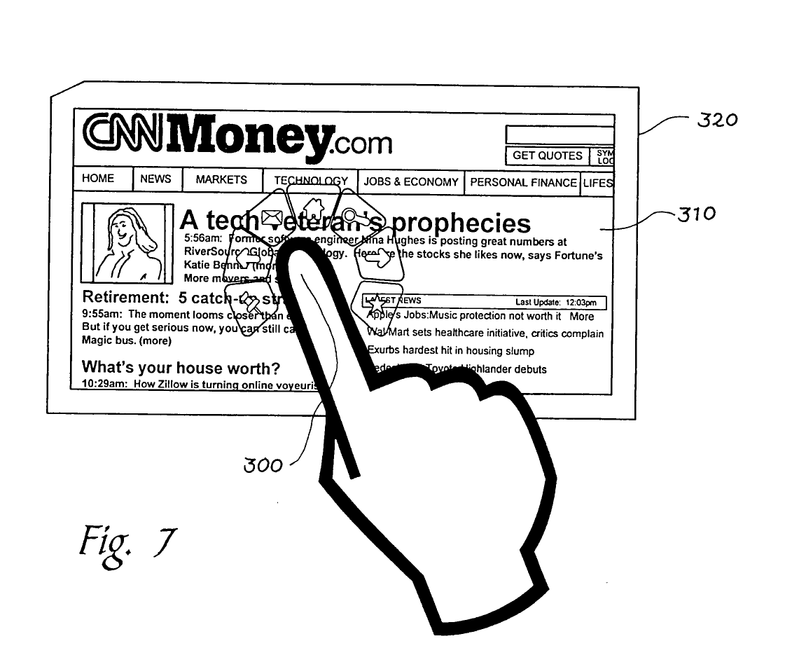

FIGS. 6 and 7 illustrate this alternate embodiment. In FIG. 6, as the user's finger 200 is about to touch a location on the touch screen display device 210 of the electronic device 220, the proximity sensor detects when a user's finger is in proximity to the location, and the circuitry generates the graphical user interface near the location. All of the relevant touch keys of the graphical user interface are literally at the user's fingertip, as compared to the playback controls shown in FIG. 5, which are at a predetermined location on the display device. When the user removes his finger 200, the graphical user interface and proximity touch keys can disappear, allowing the movie to be played without obstruction. It should be noted that while this alternative was illustrated in FIG. 6 with respect to a video player application, this functionality can be used with other applications. For example, FIG. 7 shows this functionality being used with a web browser application. As with the example shown in FIG. 6, as the user's finger 300 is about to touch a location on the touch screen display device 310 of the electronic device 320, the proximity sensor detects when a user's finger is in proximity to the location, and the circuitry generates the graphical user interface and proximity touch keys near the location. Since a different application is being used in this illustration, the types of proximity touch keys that are part of the graphical user interface are different from the ones shown in FIG. 6 (although the same type of keys can be used). Again, as compared to the navigation controls shown in the web browser application in FIG. 3, the proximity touch keys are literally at the user's fingertip, providing a convenient and intuitive graphical user interface.

Some of the following claims may state that a component is operative to perform a certain function or is configured for a certain task. It should be noted that these are not restrictive limitations. It should also be noted that the acts recited in the claims can be performed in any order—not necessarily in the order in which they are recited. Also, it is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

What is claimed is:

1. An electronic device comprising:
a display device;
an orientation sensor;
a memory storing a plurality of applications, wherein at least one of the applications is operative to output a display on the display device; and
circuitry in communication with the display device, orientation sensor, and memory, wherein the circuitry is operative to select one of the plurality of applications based on an orientation sensed by the orientation sensor.

2. The electronic device of claim 1 further comprising a user input element in communication with the circuitry, wherein user manipulation of the user input element causes the circuitry to enter a mode of operation in which the circuitry is operative to select one of the plurality of applications based on the orientation sensed by the orientation sensor.

3. The electronic device of claim 1, wherein the plurality of applications are predetermined.

4. The electronic device of claim 1, wherein the plurality of applications are chosen by a user of the electronic device.

5. The electronic device of claim 1, wherein the plurality of applications comprise at least one of the following applications: a digital audio player application, a telephony application, a web browser application, and a digital video player application.

6. The electronic device of claim 1, wherein the plurality of applications do not merely provide a different graphical user interface for a same application.

7. The electronic device of claim 1 further comprising a proximity sensor operative to sense when a user's finger is in proximity to a location on the display device, wherein the circuitry is further operative to generate a graphical user interface near the location.

8. The electronic device of claim 1 further comprising a housing formed to indicate an orientation of the electronic device.

9. An electronic device comprising:
a display device;
an orientation sensor;
a memory storing a plurality of applications, wherein the plurality of applications do not merely provide a different graphical user interface on the display device for a same application;
a user input element; and
circuitry in communication with the display device, orientation sensor, memory, and user input element, wherein the circuitry is operative to, after receiving a signal indicating manipulation of the user input element, select one of the plurality of applications based on an orientation sensed by the orientation sensor.

10. The electronic device of claim 9, wherein the plurality of applications are predetermined.

11. The electronic device of claim 9, wherein the plurality of applications are chosen by a user of the electronic device.

12. The electronic device of claim 9, wherein the plurality of applications comprise at least one of the following applications: a digital audio player application, a telephony application, a web browser application, and a digital video player application.

13. The electronic device of claim 9 further comprising a proximity sensor operative to sense when a user's finger is in proximity to a location on the display device, wherein the circuitry is further operative to generate a graphical user interface near the location.

14. The electronic device of claim 9 further comprising a housing formed to indicate an orientation of the electronic device.

15. An electronic device comprising:
a display device;
an orientation sensor;
a proximity sensor operative to sense when a user's finger is in proximity to a location on the display device;
a memory storing a plurality of applications; and
circuitry in communication with the display device, orientation sensor, proximity sensor, and memory, wherein the circuitry is operative to:
select one of the plurality of applications based on an orientation sensed by the orientation sensor; and
generate a graphical user interface near the location on the display device.

16. The electronic device of claim 15 further comprising a user input element in communication with the circuitry, wherein user manipulation of the user input element causes the circuitry to enter a mode of operation in which the circuitry is operative to select one of the plurality of applications based on the orientation sensed by the orientation sensor.

17. The electronic device of claim 15, wherein the plurality of applications are predetermined.

18. The electronic device of claim 15, wherein the plurality of applications are chosen by a user of the electronic device.

19. The electronic device of claim 15, wherein the plurality of applications comprise at least one of the following applications: a digital audio player application, a telephony application, a web browser application, and a digital video player application.

20. The electronic device of claim 15, wherein the plurality of applications do not merely provide a different graphical user interface for a same application.

21. The electronic device of claim 15 further comprising a housing formed to indicate an orientation of the electronic device.

22. A method for selecting an application in an electronic device, the method comprising:
sensing an orientation of an electronic device with an orientation sensor in the electronic device; and
selecting one of a plurality of applications stored in a memory of the electronic device based on the orientation sensed by the orientation sensor.

23. The method of claim 22 further comprising, prior to the sensing and selecting acts:
receiving user manipulation of a user input element of the electronic device, wherein the received user manipulation of the user input element enables the electronic device to perform the sensing and selecting acts.

24. The method of claim 22, wherein the plurality of applications are predetermined.

25. The method of claim 22, wherein the plurality of applications are chosen by a user of the electronic device.

26. The method of claim 22, wherein the plurality of applications comprise at least one of the following applications: a digital audio player application, a telephony application, a web browser application, and a digital video player application.

27. The method of claim 22, wherein the plurality of applications do not merely provide a different graphical user interface for a same application.

28. The method of claim 22 further comprising:
sensing when a user's finger is in proximity to a location on a display device of the electronic device; and
generating a graphical user interface near the location.

29. The method of claim 22, wherein the electronic device comprises a housing formed to indicate an orientation of the electronic device.

30. A method for selecting an application in an electronic device, the method comprising:
receiving user manipulation of a user input element of an electronic device;
sensing an orientation of the electronic device with an orientation sensor in the electronic device; and
selecting one of a plurality of applications stored in a memory of the electronic device based on the orientation sensed by the orientation sensor, wherein the plurality of applications do not merely provide a different graphical user interface for a same application.

31. The method of claim 30, wherein the plurality of applications are predetermined.

32. The method of claim 30, wherein the plurality of applications are chosen by a user of the electronic device.

33. The method of claim 30, wherein the plurality of applications comprise at least one of the following applications: a digital audio player application, a telephony application, a web browser application, and a digital video player application.

34. The method of claim 30 further comprising:
sensing when a user's finger is in proximity to a location on a display device of the electronic device; and
generating a graphical user interface near the location.

35. The method of claim 30, wherein the electronic device comprises a housing formed to indicate an orientation of the electronic device.

36. A method for selecting an application in an electronic device, the method comprising:
sensing an orientation of an electronic device with an orientation sensor in the electronic device;
selecting one of a plurality of applications stored in a memory of the electronic device based on the orientation sensed by the orientation sensor;
sensing when a user's finger is in proximity to a location on a display device of the electronic device; and
generating a graphical user interface near the location.

37. The method of claim 36 further comprising, prior to the sensing and selecting acts:
receiving user manipulation of a user input element of the electronic device, wherein the received user manipulation of the user input element enables the electronic device to perform the orientation sensing and selecting acts.

38. The method of claim 36, wherein the plurality of applications are predetermined.

39. The method of claim 36, wherein the plurality of applications are chosen by a user of the electronic device.

40. The method of claim 36, wherein the plurality of applications comprise at least one of the following applications: a digital audio player application, a telephony application, a web browser application, and a digital video player application.

41. The method of claim 36, wherein the plurality of applications do not merely provide a different graphical user interface for a same application.

42. The method of claim 36, wherein the electronic device comprises a housing formed to indicate an orientation of the electronic device.
